(19) United States
(12) Patent Application Publication
(10) Pub. No.: US 2018/0052456 A1
(43) Pub. Date: Feb. 22, 2018

(54) TESTING OF AN AUTONOMOUSLY CONTROLLABLE MOTOR VEHICLE

(71) Applicant: Robert Bosch GmbH, Stuttgart (DE)

(72) Inventors: Daniel Schoenfeld, Abstatt (DE); Marlon Ramon Ewert, Untergruppenbach (DE)

(21) Appl. No.: 15/655,117

(22) Filed: Jul. 20, 2017

(30) Foreign Application Priority Data
Aug. 18, 2016 (DE) 102016215541.5

(51) Int. Cl. G05D 1/00; G05D 1/02

(52) U.S. Cl. CPC G05D 1/0033; G05D 1/0022; G05D 2201/02; G05D 1/0212

(57) ABSTRACT

A motor vehicle is designed to be controlled autonomously. A test system for such a motor vehicle comprises a requesting device for requesting the driver-independent performance of a predetermined maneuver on the part of the motor vehicle; a scanning device for scanning a behavior of the motor vehicle; a memory for storing a predetermined behavior of the motor vehicle; and a processing device. The processing device is designed to assess an operability of the motor vehicle on the basis of a comparison of the scanned behavior with the predetermined behavior.

### CROSS REFERENCE

The present application claims the benefit under 35 U.S.C. §119 of German Patent Application No. 102016215541.5 filed on Aug. 18, 2017, which is expressly incorporated herein by reference in its entirety.

### FIELD

The present invention relates to an autonomously controllable motor vehicle. The present invention relates in particular to testing the motor vehicle in order to assess its operability.

### BACKGROUND INFORMATION

An autonomously controllable motor vehicle comprises a control unit that is able to control the motor vehicle autonomously in the longitudinal or transverse direction. In contrast to a driver assistance system, there is in this case normally no provision for a driver to control the control function. The control function must be maintained at least for the duration required for a human driver to be informed of a problem and to take control. For this purpose, a time window of a specific minimum duration is normally provided, for example approximately 15 seconds.

Within the scope of a production process, every motor vehicle is normally subjected to a final test. In this context, testing an autonomous function of the motor vehicle in particular may be difficult or expensive.

PCT Application No. WO 2015 151055 A1 provides for monitoring an autonomous motor vehicle from a system of lighting poles.

An objective of the present invention is to provide an improved technology for testing an autonomously controllable motor vehicle. The present invention may achieves this objective. Preferred specific embodiments are described herein.

### SUMMARY

A motor vehicle is designed to be controlled autonomously. A test system for such a motor vehicle includes a requesting device for requesting the driver-independent performance of a specific maneuver on the part of the motor vehicle; a scanning device for scanning a behavior of the motor vehicle; a memory for storing a predetermined behavior of the motor vehicle; and a processing device designed to assess an operability of the motor vehicle on the basis of a comparison of the scanned behavior with the predetermined behavior.

The test system is in particular able to perform a final-assembly inspection of a motor vehicle following its manufacture and prior to its delivery. For this purpose, it is possible that monitoring on the part of a human being is not necessary. In particular, it is possible to test a series of identical motor vehicles in a predetermined test course with a sequence of predetermined maneuvers in order to avoid a systematic error or a production error. A test drive on the part of a human tester may be limited to a lower number of tests or may be omitted entirely.

The behavior may include any effect of the motor vehicle on its surroundings that is controlled autonomously, that is, independently of the driver, when the predetermined maneuver is performed. It is particularly preferred that the behavior comprises a driver-independent longitudinal and/or lateral control of the motor vehicle. Additionally, it is possible to perform autonomously for example a navigation, an obstacle avoidance or a tactical or strategic planning of a trajectory to be followed. Using the test system, it is possible to test, in an improved manner, the operability of a modern motor vehicle, which is capable, partially or entirely, to be moved in public road traffic in a driver-independent manner.

In one variant, the scanning device is mounted on board of the motor vehicle and the processing device is mounted outside of the motor vehicle. For this purpose, a wireless transmission device is provided between the scanning device and the processing device. The scanning device may comprise for example an ultrasonic sensor, a camera, a video camera, a radar or lidar device. The wireless transmission device may comprise in particular a car-to-infrastructure (C2I) interface or a car-to-car (C2C) interface. In this variant, the scanning device is able to use in particular sensors that are already provided on board of the motor vehicle. The sensors may thereby be subjected to a special test. Furthermore, it is possible to test a synthesis of sensor data (data fusion). By processing the collected data outside of the motor vehicle, it is possible to reduce a probability of a faulty component on board of the motor vehicle compromising the correct performance of the assessment of the operability.

In another variant, the scanning device is mounted outside of the motor vehicle and the processing device is mounted on board the motor vehicle. The wireless transmission device is in this instance provided as in the previous variant. By scanning the behavior of the motor vehicle from outside, it is possible to exclude in an improved manner an error in the area of the sensor system. In particular, it is possible to base the test exclusively on the externally observable behavior of the motor vehicle.

In another specific embodiment, the two variants may also be integrated with each other in that for example a scan occurs both on board the motor vehicle as well as also from outside and the processing is performed alternatively on-board or off-board.

In another specific embodiment, the processing device is designed to take over control of the motor vehicle if a lack of operability was determined.

In particular, it is possible to terminate the autonomous driving function when an error occurs. It is possible to brake the motor vehicle to a standstill in order to prevent a collision with an object or a person. This function may also be employed if a driver-controlled maneuver fails and the motor vehicle behaves differently than should have been expected according to the inputs of the driver.

In yet another specific embodiment, the behavior comprises the activation or deactivation of a signaling device of the motor vehicle. The signaling device may be directed in particular toward the outside and include for example a backup light, a direction indicator, a warning light or another signaling device. It is also possible to use an acoustic signaling device such as a horn in connection with the autonomous control of the motor vehicle.

A method for testing the above-described autonomously controllable motor vehicle includes steps of requesting the driver-independent performance of a predetermined driving maneuver on the part of the motor vehicle; the scanning of a behavior of the motor vehicle; the comparison of the scanned behavior with a predetermined behavior; and the assessment of the operability of the motor vehicle on the basis of the comparison.

The method may be implemented in particular by a processing device that preferably comprises a programmable microcomputer. The method or portions of it may exist as a computer program product having program code means for implementing the described method. For this purpose, the computer program product may run on the processing device or may be stored on a computer-readable data carrier.

### BRIEF DESCRIPTION OF THE DRAWINGS

Specific embodiments of the present invention are described in more detail below with reference to the figures.

FIG. 1 shows an autonomously controllable motor vehicle.

FIG. 2 shows a test system for testing an autonomously controllable motor vehicle.

FIG. 3 shows a flow chart of a method for testing an autonomously controllable motor vehicle.

### DETAILED DESCRIPTION OF EXAMPLE EMBODIMENTS

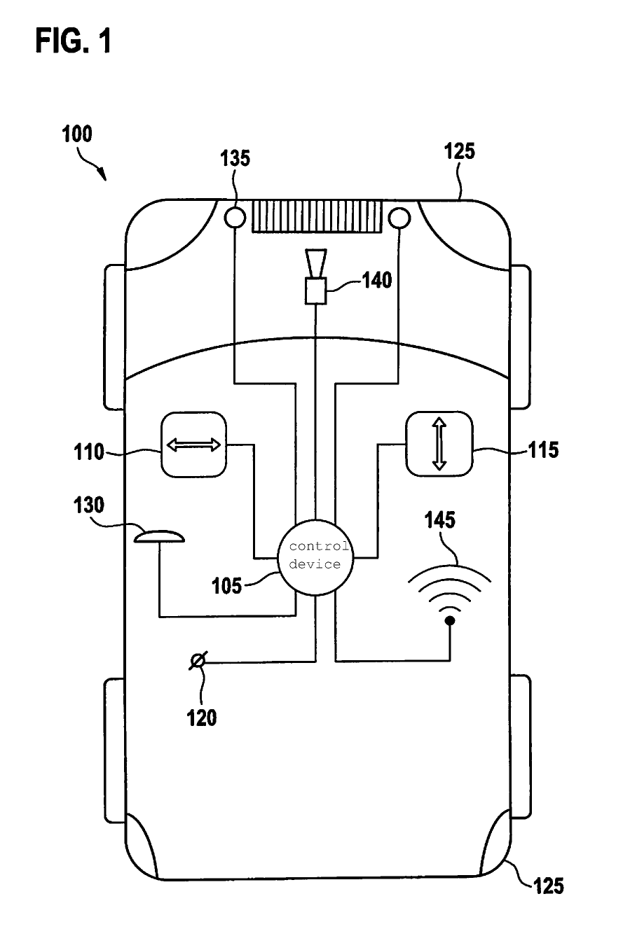

FIG. 1 shows an autonomously controllable motor vehicle 100. Motor vehicle 100 is designed to be controlled, entirely or partially, in an autonomous manner. For this purpose, motor vehicle 100 comprises in particular a control device 105, which is connected to at least one of a lateral control 110, a longitudinal control 115 and an interface 120. Interface 120 is preferably connected to another control unit on board of motor vehicle 100, it being possible to control, via interface 120, functions of motor vehicle 100, which comprise in particular an effect of motor vehicle 100 toward the outside. A direction indicator 125 or another optical or acoustic signaling device of motor vehicle 100 may be controlled via interface 120 for example. It is preferred that information relating in particular to a driving state of motor vehicle 100 may be received by control device 105 via interface 120.

Furthermore, motor vehicle 100 may include a navigation device 130 an ultrasonic sensor 135 or a sensor 140 for scanning a surroundings of motor vehicle 100. Sensor 140 may include for example an optical camera, a radar module or a LiDAR module. It is furthermore preferred that a wireless interface 145 is provided in order to transmit information between motor vehicle 100 and another motor vehicle or a central facility outside of motor vehicle 100.

Within the scope of a manufacture of motor vehicle 100, a functional test is to be performed that ensures in particular that a behavior of motor vehicle 100 corresponds to an expected outward effect when motor vehicle 100 performs a predetermined maneuver independently of a driver. The behavior may be produced in particular via the position, speed or acceleration of motor vehicle 100. The behavior may also be achieved by an outward effect of a device or a subsystem of motor vehicle 100, for example a lighting or acoustic device.

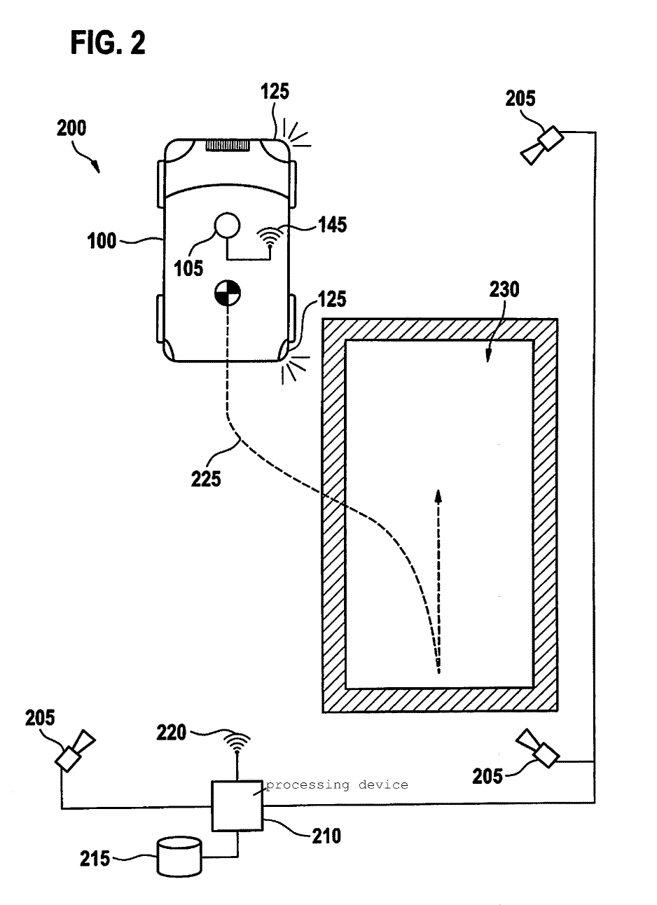

FIG. 2 shows a test system 200 for testing an autonomously controllable motor vehicle, here motor vehicle 100 from FIG. 1.

System 200 comprises one or multiple scanning devices 205 for scanning a behavior of motor vehicle 100 as well as a processing device 210. If it is mounted on board motor vehicle 100, scanning device 205 may comprise in particular an ultrasonic sensor 135, a sensor 140, navigation device 130 or a subsystem connected via interface 120. It is preferred that furthermore a data memory 215 is connected to processing device 210. In the specific embodiment shown, processing device 210 is located outside of motor vehicle 100. An optional wireless interface 220 is designed to allow for an exchange of data with wireless interface 145 on board motor vehicle 100.

In a preferred specific embodiment, a surroundings of motor vehicle 100 are controlled, that is, they are neither part of public road traffic nor are they otherwise accessible to road users or persons. The surroundings preferably comprise a dedicated test site, which may have a boundary that prevents the autonomously driving motor vehicle 100 from uncontrolled removal.

In the specific embodiment shown, processing device 210 is designed to select from data memory 215 a maneuver stored therein, which motor vehicle 100 is to perform. A request for the performance is then transmitted via wireless interfaces 220, 145 to motor vehicle 100. The maneuver is assigned a predetermined behavior, which processing device 210 is likewise able to access. If motor vehicle 100 obeys and performs the requested maneuver autonomously, then scanning device 205 is able to scan its behavior and compare it to the predetermined behavior from data memory 215. If a deviation is ascertained in the process that lies above a tolerable magnitude, then it is possible to rate motor vehicle 100 as not fully functional. Otherwise, the operability may be confirmed. It is preferred that motor vehicle 100 performs multiple maneuvers in succession and that the operability is determined on the basis of the comparison of the behavior with the respectively associated predetermined behavior.

It should be noted that in another specific embodiment, processing device 210 may also be mounted on board motor vehicle 100. Processing device 210 for example may be coupled to control device 105 via interface 120, may be designed to be integrated with control device 105 or may operate autonomously without a direct data connection. Moreover, it is possible for processing device 210 to be mounted temporarily on board motor vehicle 100 in order to perform the test or tests. Processing device 210 is able to access data that are intended for other purposes on board motor vehicle 100. For example, the position of motor vehicle 100 may be determined using navigation device 130 and the determined position may be provided to processing device 210. Independently of the latter option, it is also possible to determine the position of motor vehicle 100 using scanning devices 205. The scanning result may be transmitted to motor vehicle 100 via wireless interfaces 220, 145. The selection and request of a maneuver that is to be performed by motor vehicle 100 may also occur on board motor vehicle 100.

The behavior of motor vehicle 100 may include its position, a series of positions or a complete trajectory 225. In the exemplary representation of FIG. 2, the predetermined maneuver concerns the automatic parking of motor vehicle 100 in a simulated parking space 230. For this purpose, motor vehicle 100 is first to stop correctly, set the direction indicator 125, park rearwards and correct forwards to the optimal distance in the longitudinal direction. This behavior is stored in data memory 215 and is preferably compared by processing device 210 to a behavior of motor vehicle 100 that was scanned previously from outside motor vehicle 100 using scanning devices 205 or on board motor vehicle 100. If an intolerable deviation is determined in the process or if the risk of a collision of motor vehicle 100 with an object in its surroundings is great, then processing device 210 is able to switch off the autonomous control of motor vehicle 100. Subsequently, processing device 210 is able to perform an emergency maneuver, particularly braking motor vehicle 100 to a standstill.

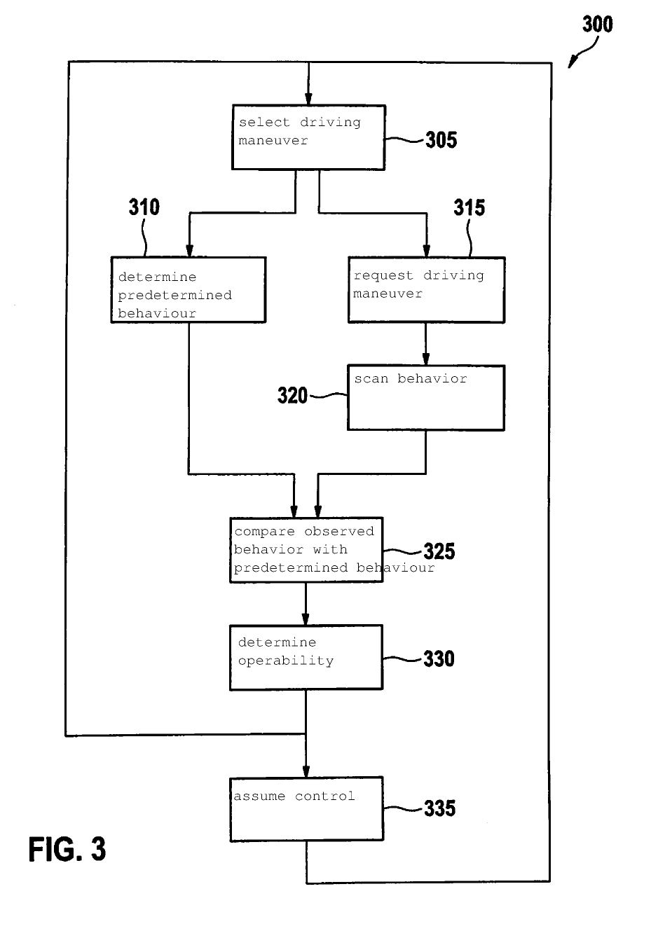

FIG. 3 shows a flow chart of a method 300 for testing an autonomously controllable motor vehicle such as motor vehicle 100 from FIG. 1.

Method 100 may be carried out in particular partially or completely on control device 105 and/or processing device 210.

In a step 305, a driving maneuver is selected, which motor vehicle 100 is to perform. The maneuver is preferably stored in data memory 215, which may be situated on board motor vehicle 100 or outside. In a step 310, a predetermined behavior of motor vehicle 100 is determined, which is associated with the maneuver. The predetermined behavior may also be stored in data memory 215 or may be determined parametrically for example.

In parallel, the driving maneuver is requested in a step 315 by the autonomous control of motor vehicle 100. Subsequently, while motor vehicle 100 is controlled autonomously through the maneuver, the behavior of motor vehicle 100 is scanned in a step 320. During or following the scanning process, the observed behavior is compared in a step 325 with the predetermined behavior, it being possible to determine deviations in the process. In a step 330, the operability of motor vehicle 100 is determined on the basis of the comparison.

If method 300 is run through multiple times, in particular with different driving maneuvers, then the operability can only be determined when all or at least certain driving maneuvers have been run through successfully, that is, without excessive deviations from the associated predetermined behavior of motor vehicle 100.

Optionally, in a step 335, it is possible to assume control over motor vehicle 100 if an error is determined on board motor vehicle 100 or if an immediate risk of damage caused by a malfunction is determined. In this case, it is possible to assume control over motor vehicle 100 and to bring motor vehicle 100 for example into a safe driving state.

What is claimed is:

1. A test system for an autonomously controllable motor vehicle, the test system comprising:
a requesting device for requesting a driver-independent performance of a predetermined maneuver by the motor vehicle;
a scanning device for scanning a behavior of the motor vehicle;
a memory for storing a predetermined behavior of the motor vehicle; and
a processing device for assessing operability of the motor vehicle based on a comparison of the scanned behavior with the predetermined behavior.

2. The test system as recited in claim 1, wherein the behavior includes at least one of a driver-independent longitudinal control of the motor vehicle, and a driver-independent lateral control of the motor vehicle.

3. The test system as recited in claim 2, wherein the test system is designed to determine a position of the motor vehicle.

4. The test system as recited in claim 3, wherein the scanning device is mounted on board motor vehicle and the processing device is mounted outside of motor vehicle, and a wireless transmission device is provided between the scanning device and the processing device.

5. The test system as recited in claim 3, wherein the scanning device is mounted outside of motor vehicle and the processing device is mounted on board motor vehicle, and a wireless transmission device is provided between the scanning device and the processing device.

6. The test system as recited in claim 1, wherein the processing device is designed to take over a control of the motor vehicle if a lack of operability was determined.

7. The test system as recited in claim 1, wherein the behavior includes activation or deactivation of a signaling device of the motor vehicle.

8. A method for testing an autonomously controllable motor vehicle, comprising:
requesting a driver-independent performance of a predetermined maneuver by the motor vehicle;
scanning a behavior of the motor vehicle;
comparing the scanned behavior with a predetermined behavior; and
assessing operability of the motor vehicle based on the comparison.

9. A non-transitory computer-readable data carrier on which is stored program code for testing autonomously controllable motor vehicle, the program code, when executed by a processor, causing the processor to perform:
requesting a driver-independent performance of a predetermined maneuver by the motor vehicle;
scanning a behavior of the motor vehicle;
comparing the scanned behavior with a predetermined behavior; and
assessing operability of the motor vehicle based on the comparison.
